(19) United States
(12) Patent Application Publication
(10) Pub. No.: US 2002/0070989 A1
(43) Pub. Date: Jun. 13, 2002

(54) Circuit for driving heater of printhead and device employing the same

(76) Inventors: Li-Chang Yang, Hsin-Chu (TW); Yun-Lung Yang, Hsin-Chu (TW); Hung-Tsung Wang, Taipei (TW)

Correspondence Address: CROCKETT & CROCKETT, 24012 CALLE DE LA PLATA, SUITE 400, LAGUNA HILLS, CA, 92653, US

(21) Appl. No.: 09/768,644

(22) Filed: Jan. 24, 2001

(30) Foreign Application Priority Data
Dec. 11, 2000 (CN) 89126326

(51) Int. Cl. B41J 29/38

(52) U.S. Cl. 347/9

(57) ABSTRACT

The present invention discloses a circuit for driving a heater of a printhead and a device employing the same. The device primarily includes a plurality of driving units and a plurality of electric resistant heaters. Each driving unit includes a transistor or at least one pair of transistors to form a Darlington pair, and has a base node connecting to a correspondent receive node for receiving correspondent address signals. Each electric resistant heater defines a first end connecting to the collector node of each driving unit, and a second end connecting to a current source. The driving unit of the present invention is a common emitter, which results in higher power gain. According to the driving circuit and device of the present invention, the power of electric resistant heaters is more controllable, and the stability of outputing current is improved.

### FIELD OF THE INVENTION

The present invention relates to a circuit for driving a heater of a printhead and a device employing the same and, particularly to a circuit and a device employing the same used in a printhead of a thermal inkjet printer.

### BACKGROUND OF THE INVENTION

Thermal inkjet printers are one of the most popular printing apparatuses, in which a thin-film resistor for heating ink is used.

U.S. Pat. No. 5,598,189 and U.S. Pat. No. 5,681,764 disclosed a heating device, and FIG. 9 shows the driving circuit thereof. Such driving circuit includes at least one pair of transistors t11, t12 to form a Darlington pair in a common collector. The transistor t12 connects with an address signal line, and the electric resistant heater r11 is deposited between the emitter of the transistor t11 and a control terminal vm. The voltage drop between vs and vm is nearly equal to the sum of the voltage drop between collector and emitter of the transistor t12, the voltage drop between collector and emitter of the transistor t11, and the voltage drop across the electric resistant heater r11. Obviously, the power of the electric resistant heater r11 is limited because of V_{CE,2} and V_{BE,1}. Furthermore, when vs is zero, the electric resistant heater r11 may be misactuated from the address line connected with the transistor t12, which is a problem for applying it.

Therefore, it s desired to improve the driving circuit and devices employing the same.

### SUMMARY OF THE INVENTION

The main object of the present invention is to provide a circuit for driving a heater of a printhead and a device employing the same, so as to improve the power and stability of the heater.

The second object of the present invention is to provide a circuit for driving a heater of a printhead and a device employing the same, so as to meliorate the stability of current in the circuit.

To achieve the above objects, the circuit for driving a heater of a printhead mainly includes a common emitter, a plurality of driving units, and a plurality of electric resistant heaters. Each of the driving units includes a first transistor, which has an emitter node connecting to the common emitter, a collector forming a respective collector contact, and a base connecting to a respective base node for receiving correspondent address signals. Each of the electric resistant heaters defines a first end connecting to the respective collector contact, and a second connecting to a current source.

Additionally, each of the aforementioned driving units may further include a second transistor to form a Darlington pair.

Furthermore, each of the driving unit can combine a current mirror to the base node for stabilizing the current, or include a MOS transistor in the Darlington pair.

The circuit of the present invention can be further fabricated on a semiconductor substrate by well-known processes.

### BRIEF DESCRIPTION OF THE DRAWINGS

FIG. 1 shows a block diagram of a heater and driving circuit of the present invention;

FIG. 2 shows the driving circuit of FIG. 1;

FIG. 3 shows a matrix including a plurality of blocks;

FIG. 4 shows a driving circuit connecting with a current mirror;

FIG. 5 shows a driving circuit connecting to a MOS transistor;

FIG. 6 shows another type of a Darlington pair;

FIG. 7 shows the driving circuit of FIG. 2 connected in another manner;

FIG. 8 shows the cross section and connecting of the transistor T 1 of the present invention; and

FIG. 9 shows a traditional driving circuit similar to the present invention.

### DETAILED DESCRIPTION OF THE PREFERRED EMBODIMENTS

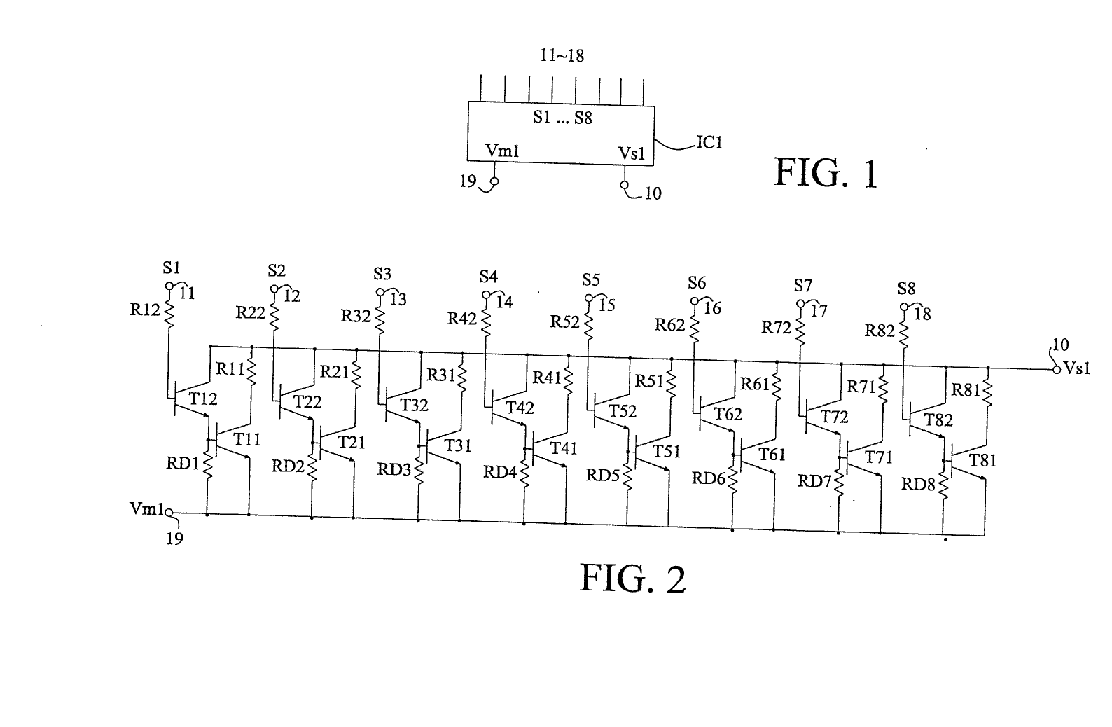

Please refer to FIG. 1, which shows a block including a heater and driving circuit of the present invention. The amounts of address lines in the block are not limited and able to fit inkjet printers in practice.

FIG. 2 shows the driving circuit of FIG. 1, wherein eight driving units are primarily formed by eight same Darlington pairs T11-T12, , T81-T82. Each of eight first transistors T11, , T81 includes an emitter connecting to a common emitter, a collector connecting to a respective resistant heater R11, , R81, and a base connecting to a respective second transistor T12,, T82. The common emitter is connected to a control terminal Vm1 for receiving control signals. Each of the eight second transistors T12, , T82 includes an emitter connecting to the respective base of the first transistor T11, , T81, a collector connecting to a common current source Vs1, and a base connecting to a respective resistor R12, , R82. Each of the resistor R12, , R82 is connected to a respective address terminal 11 . . . 18 for receiving an address signal S1 S8. Additionally, eight electric resistors RD1 RD8 are respectively connected between the bases and the emitters of the first transistors T1, , T81.

The resistant heaters R11, , R81 are connected to the common current source Vs1 at the end opposite the end connected to the collectors of the first transistors T11, , T81, whereby current can individually flow therethrough when address signals S1, , S8 are received from the address terminal 11, , 18. Therefore, the electricity can be converted into heating energy at a certain position.

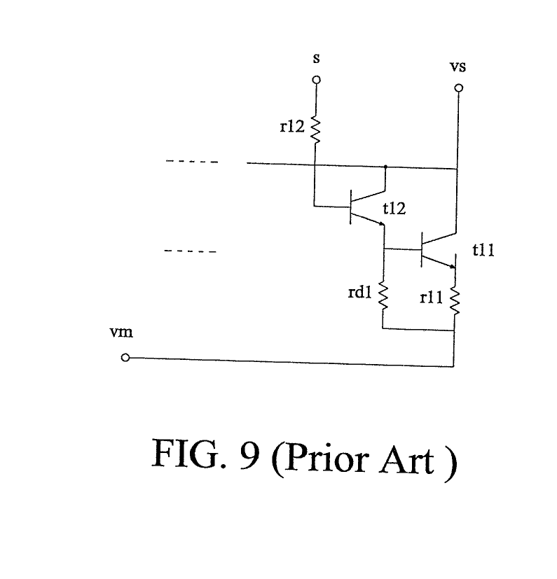

Since the current path toward the resistant heaters R11, , R81 are fixed, i.e., from the common source Vs1, it s obvious that the system of the present invention can be exactly controlled. The disadvantages caused by the prior device as shown in FIG. 9 can be avoided.

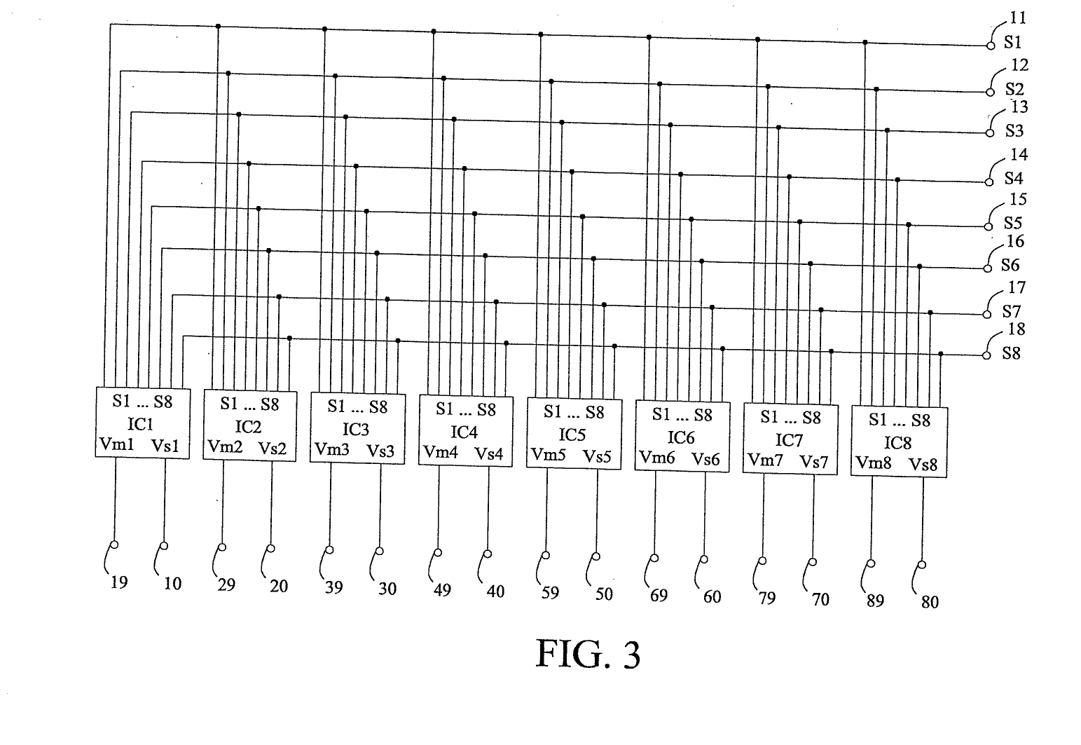

FIG. 3 shows an 8×8 array formed by eight blocks of FIG. 1, in which the address lines 11-18 are interconnected. Such matrix and the blocks can be increased to fit a practical printer.

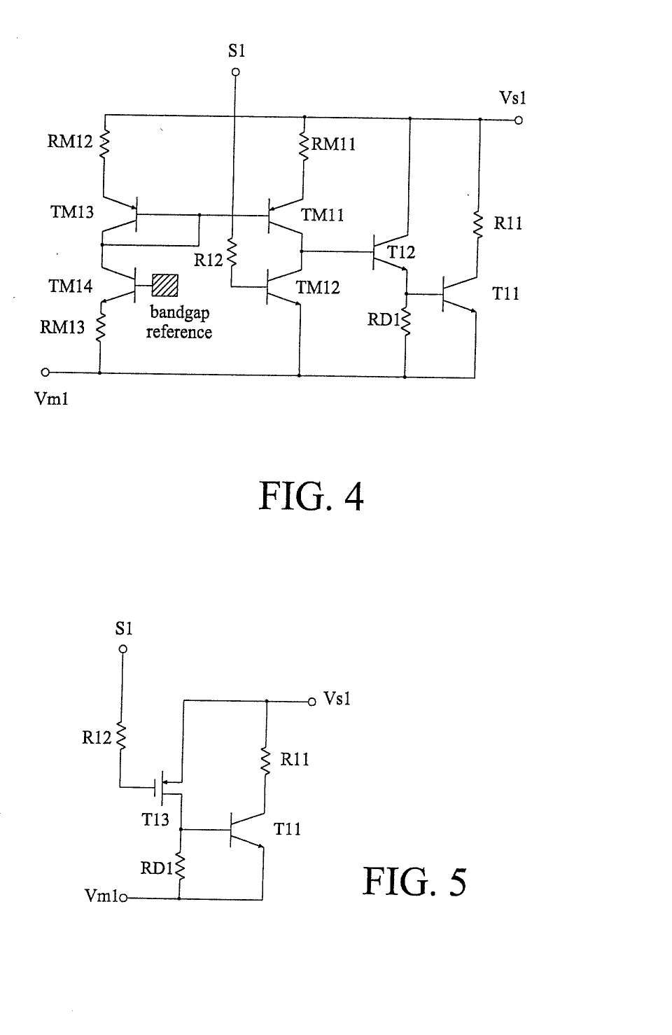

In order to keep the output current stable, a current mirror to the base of transistor T12 should be further included. FIG. 4 shows the driving circuit of FIG. 1 connecting with the current mirror. The current mirror includes two PNP transistors TM11, TM13 and two NPN transistors TM12, T14. The PNP transistors TM11, TM13 are connected with each other by bases thereof, and each of them has an emitter connecting to an electric resistor RM11, RM12, and a collector connects to a respective collector of the NPN transistor TM12, T14. In this embodiment, the collectors of the transistors TM11, TM12 are also connected to the base of the transistor T12. The resistors RM11, RM12 are then commonly connected to the voltage source Vs1. The emitters of the transistors TM12, TM14 and T11 are all connected to the common emitter Vm1. The base of the transistor TM12 can receive signal S1, and the base of the transistor TM14 is connected to a bandgap reference for obtaining stable voltage.

FIG. 5 shows another type of the Darlington driving unit of the present invention, wherein the transistor T12 is replaced with an MOS transistor T13. Such Darlington driving unit can provide advantages of higher integration, lower power consumption, higher input resistance, and lower input current.

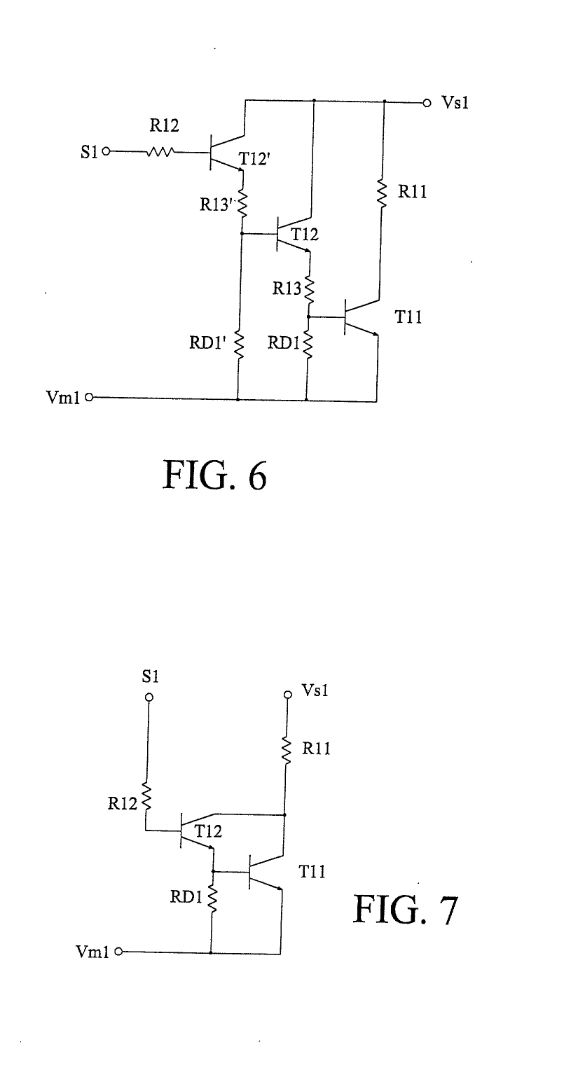

FIG. 6 shows another type of a Darlington pair, in which three transistors T11, T12 and T12 are connected so as to reduce the required current flowing through the bases.

FIG. 7 shows another driving circuit of FIG. 2, in which the collector of the transistor T12 is connected between the collector of the transistor T11 and the electric resistant heater R11.

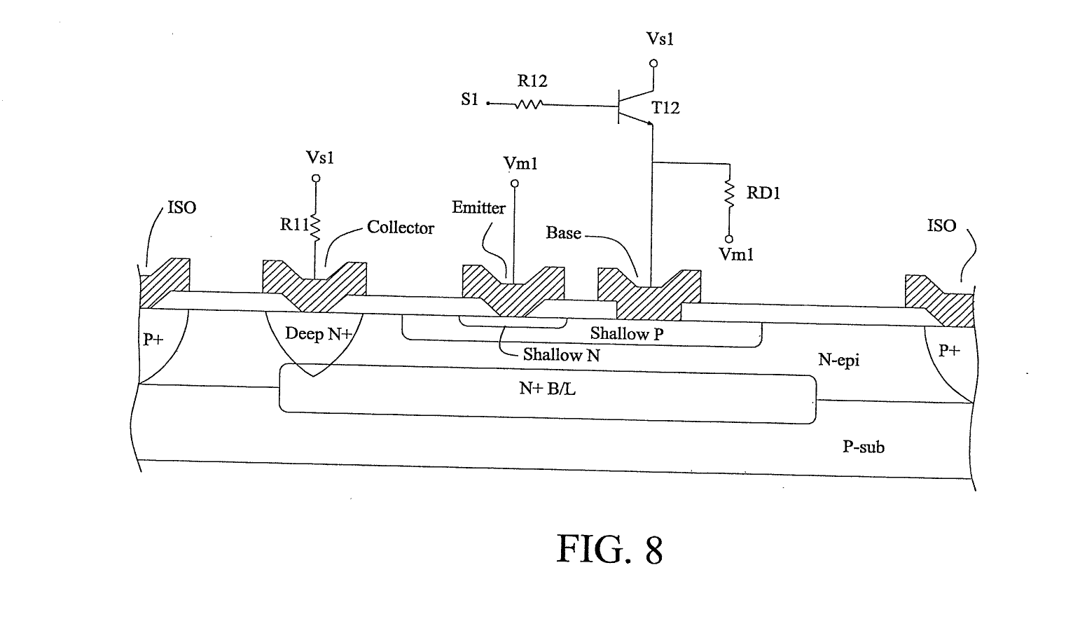

FIG. 8 shows a cross section and connecting circuit of an NPN transistor T11 used in the present invention. The NPN transistor T11 can be fabricated by the following processes:

(a) Providing a P-substrate;

(b) B/L—initial oxide, photo/etch, implant, and drive-in;

(c) Epitaxy;

(d) Iso—photo/etch, deposition, and drive-in;

(e) Deep N+—photo/etch, deposition, and drive-in;

(f) Shallow P—photo/etch, implant, and drive-in;

(g) Implant R*—photo/etch*, and implant*;

(h) Shallow N+—photo/etch, and deposition;

(i) Field implant*—photo/etch*, implant*, and drive-in;

(j) Contact—photo/etch;

(k) Metal 1—deposition, photo/etch, and alloy;

(l) Planarization*—deposition (PECVD undoped oxides)*, photo/etch*, and deposition (PECVD undoped oxides)*;

(m) via*—photo/etch*; and

(n) metal2*—deposition*, and photo/etch*.

* means optional.

Since the processes aforementioned are well known for anyone skilled in the semiconductor industry, it s not necessary to describe in detail anymore.

Please note that the above embodiments are to explain the present invention, and shouldn t be used to limit the scope of the present invention.

What is claimed is:

1. A circuit for driving a heater of a printhead, being formed on a semiconductor substrate, said circuit comprising:
a common emitter;
a plurality of driving units, each driving unit comprising a first transistor, said first transistor comprising:
an emitter connecting to said common emitter;
a collector forming a respective collector contact; and
a base connecting to a respective base node for receiving correspondent address signals; and
a plurality of electric resistant heaters, each electric resistant heater defining a first end connecting to said respective collector contact, and a second connecting to a current source.

2. The circuit of claim 1, wherein each said driving unit further comprises a current mirror connecting to said base of said first transistor for stabilizing the current flowing therethrough.

3. The circuit of claim 1, wherein said base and said emitter of each said first transistor further comprises an electric resistor therebetween.

4. The circuit of claim 1, wherein each of said driving units further comprises a second transistor to form a Darlington pair, said second transistor having a collector connecting to said current source, a base replacing said base of said first transistor to connect to said base node, and an emitter connecting to said base of said first transistor.

5. The circuit of claim 4, wherein each said driving unit further comprises a current mirror connecting to said base of said second transistor for stabilizing the current flowing therethrough.

6. The circuit of claim 4, wherein said base and said emitter of each said first transistor further comprises an electric resistor therebetween.

7. The circuit of claim 4, wherein said base of each said second transistor is connected to an electric resistor.

8. The circuit of claim 1, wherein each said driving unit further comprises a MOS transistor to form a Darlington pair.

9. A circuit for driving a heater of a printhead, which is formed on a semiconductor substrate; comprising:
a common emitter;
a plurality of driving units, each said driving unit comprising:
a first transistor having an emitter node connecting to said common emitter, a collector forming a collector node, and a base; and
a second transistor having an emitter node connecting to said base of said first transistor, a collector connecting to a current source, and a base node connecting to a respective address signal receiver for receiving address signals;
a plurality of electric resistant heaters, each said electric resistant heater defining a first end respectively connecting to said collector node, and a second end connecting to said current source.

10. A device for driving a resistant heater, being employed in a printhead of a thermal inkjet printer, and comprising:
a bipolar transistor driving unit, defining a driving collector node, a driving base node, and a driving emitter node; said bipolar transistor driving unit comprising:
a first transistor having a collector forming said driving collector node, an emitter forming said driving emitter node, and a base; and
a second transistor having a collector connecting to a constant DC source, an emitter connecting to said base of said first transistor, and a base forming said driving base node;
a first electric resistor defining a first end connecting to a signal receiver, and a second end connecting to said driving base node;
a second electric resistor defining a first end connecting to said emitter of said second transistor, and a second end connecting to said driving emitter node; and
an electric resistant heater defining a first end connecting to said constant DC source, and a second end connecting to said driving collector node.

11. A device for driving a heater, being employed in a printhead of a thermal inkjet printer, and comprising:
a plurality of driving circuits, each said driving circuit comprising:
a plurality of driving units, each said driving unit comprising a driving base node, a collector contact, and a driving emitter node; and
a plurality of electric resistant heaters, each said electric resistant heater defining a first end connecting to a current source, and a second end connecting to said collector contact;
a plurality of control terminals and each correspondingly connecting to said driving emitter node for receiving control signals;
at least one current source for providing electrical energy to said driving circuit; and
a plurality of address signal receivers correspondingly connecting to said driving base node for receiving address signals.

12. The device of claim 11, wherein each said driving unit further comprises a current mirror for stabilizing the current flowing therethrough.

13. The device of claim 11, wherein each said driving unit comprises a first transistor and a second transistor to form a Darlington pair, said first transistor having a collector forming said collector contact, a base, and an emitter forming said driving emitter node; said second transistor having a driving collector connecting to said current source, a base forming said driving base node, and an emitter connecting to said base of said first transistor.

14.The device of claim 13, wherein each said driving unit is connected to a current mirror for stabilizing the current flowing therethrough.

15. The device of claim 13, wherein said second transistor is a MOS transistor.

16. The device of claim 11, wherein said driving base node and said driving emitter node of each said driving unit is connected to an electric resistor therebetween.

17. The device of claim 11, wherein said driving base node of each said driving unit and said correspondent address signal receiver is connected to an electric resistor therebetween.
